(19) United States
(12) Patent Application Publication
(10) Pub. No.: US 2006/0091362 A1
(43) Pub. Date: May 4, 2006

(54) Composite electrochemical material

(76) Inventors: Michael R. Wixom, Ann Arbor, MI (US); Chuanjing Xu, Ann Arbor, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/261,355

(22) Filed: Oct. 28, 2005

Related U.S. Application Data
(60) Provisional application No. 60/624,279, filed on Nov. 2, 2004.

(51) Int. Cl. H01B 1/12

(52) U.S. Cl. 252/500

(57) ABSTRACT

A composite material includes a first phase which is present in the form of a plurality of particles comprised of a material having the general formula LiₓM_{y}(PO₄)_{z} wherein M is at least one metal, x is equal to or greater than zero, and y and z are each, independently, greater than zero. The material includes a second phase which is at least partially present in the form of a plurality of elongated filaments which extend between and establish electrical contact with at least two particles of the first phase. The filaments are comprised of a material which includes phosphorus and at least one of the at least one metal M. The material of the second phase has an electrical conductivity which is greater than the electrical conductivity of the material of the first phase. Also disclosed are methods for manufacturing the material. The material has utility as an electrode material for devices such as lithium batteries.

### RELATED APPLICATION

This application claims priority of U.S. Provisional Patent Application Ser. No. 60/624,279 filed Nov. 2, 2004, entitled “Composite Electrochemical Material.”

### FIELD OF THE INVENTION

This invention relates generally to materials having utility in electrochemical devices, such as batteries, and the like, as well as to methods for their manufacture. Specifically, the invention relates to composite materials which include a metal phosphate phase. More specifically, the invention relates to a composite material which includes a lithiated metal phosphate phase together with a second conductivity enhancing phase, as well as methods for preparing the materials, and electrodes which incorporate the materials.

### BACKGROUND OF THE INVENTION

Lithiated transition metal phosphates, such as LiFePO₄, including various doped and modified versions thereof, are finding increasing utility as electrochemical materials, and in particular as cathode materials for lithium batteries. Such materials are disclosed in U.S. Pat. Nos. 6,730,281; 6,855,273; and 6,514,640; as well as in published U.S. Application 2004/0086445, among others. While such materials have a very good capacity for lithium ions, they have relatively low electron conductivities, and this factor has limited their efficiency and utility. Hence, various efforts have been undertaken to dope, modify, or otherwise supplement such materials to enhance their electrical conductivity.

As will be explained hereinbelow, the present invention provides a composite material based upon lithiated metal phosphates. The composite material has a unique microstructure, and as a result, combines good electrical conductivity with high lithium ion capacity. The materials of the present invention are simple and economical to synthesize, and have very good utility as cathodes for lithium batteries.

### BRIEF DESCRIPTION OF THE INVENTION

Disclosed herein is a composite material. The material includes a first phase which is present in the form of a plurality of particles comprised of a material having the general formula LiₓM_{y}(PO₄)_{z} wherein M is at least one metal, x is equal to or greater than 0, and y and z are each, independently, greater than 0. The material includes a second phase which is at least partially present in the form of a plurality of elongated filaments, each of which extends between, and establishes electrical contact with, at least two particles of the first phase. The filaments are comprised of a material which includes P, and at least one of said at least one metal M. The material of the second phase has an electrical conductivity which is greater than the electrical conductivity of the material of the first phase. In some particular embodiments the metal M includes Fe. In particular formulations of this embodiment, the second phase includes a material selected from the group consisting of Fe₂P₂O₇, FeP, Fe₂P, and Fe₃P, taken either singly or in combination.

In certain embodiments, the first phase comprises, on a molar basis, 80-90% of the composite material and the second phase comprises, on a molar basis, 5-20% of the composite material. In certain embodiments, at least one of the phases includes V; and in particular instances, the concentration of V in the filaments of the second phase is greater than the concentration of V in the particles of the first phase.

The material of the present invention may be prepared by a process wherein a starting mixture which includes said one or more metal M, a phosphate ion, optionally Li, and a catalyst which promotes reduction of the phosphate ion is heated in a reducing atmosphere. In such instance, the catalyst may comprise V.

Also disclosed herein are electrodes which incorporate the composite material of the present invention as well as batteries such as lithium ion batteries which include those electrodes.

### DETAILED DESCRIPTION OF THE INVENTION

The composite material of the present invention includes two distinct phases. The first phase is present in the form of a plurality of particles comprised of a material having a general formula: LiₓM_{y}(PO₄)_{z} wherein M is at least one metal, x is equal to or greater than 0, and y and z are each, independently, greater than 0. The composite material includes a second phase which is at least partially present in the form of a plurality of elongated filaments. Each filament extends between, and establishes electrical contact with, at least two particles of the first phase. The filaments are comprised of a material which includes at least the metal M and phosphorous. The second phase material may optionally include oxygen; however, the oxygen-containing material is a subphosphate, hence the atomic ratio of oxygen to phosphorous is less than 4:1. The material of the second phase has an electrical conductivity which is greater than the electrical conductivity of the material of the first phase. The material of the second phase may additionally have a lithium ion conductivity that is greater than that of the first phase.

Some portion of the material of the second phase may be present in a non-filament form. For example this non-filament portion of the second phase may be in the form of particles distinct from the particles of the first phase; the non-filament second phase material may also be present in or on the surface of the particles of the first phase. This non-filament second phase material may also contribute to the performance of the composite material of the present invention.

The materials of the first phase have a good capacity for retaining lithium ions, but typically have a relatively low electrical conductivity. The material of the second phase generally has a reasonably good electrical conductivity. While not wishing to be bound by speculation, the inventors hereof postulate that the unique structure of the composite material of the present invention coupled with the properties of the materials from which it is comprised provides for a composite electrical material which combines a high capacity for lithium ions with good electrical and ionic transport. The distribution of the filaments of the second material provides for electrical conductivity between particles of the first phase. The composition and structure of the material of the present invention also facilitates lithium ion transport, both between particles and between particles and a battery electrolyte. In this manner, the material provides enhanced cathode performance in electrochemical devices, such as lithium batteries.

Within the context of this invention, the filaments of the second phase are understood to be generally elongated bodies of second phase material, and in that regard, have an aspect ratio, which is understood to be the ratio of length to width, which is greater than 1, and generally greater than 3, and in certain instances, at least 10. The microstructure of the materials of the present invention has been confirmed by electron microscopy.

The ratio of the first to the second phase can vary over a relatively wide range, depending upon the composition and intended utility of the material. In one specific group of embodiments, the first phase comprises, on a molar basis, 80-90% of the composite material and the second phase comprises, on a molar basis, 5-20% of the material. In a particular group of materials, the first phase comprises 85-90 molar percent of the material and the second phase comprises 10-15 molar percent of the material.

In one specific class of materials, the metal M comprises iron, either alone or with other metals. The first phase is of the general formula LiₓFe(PO₄) wherein x is less than or equal to 1. This material may also include dopants and/or modifiers. The second phase is a reduced form of iron phosphate and may comprise one or more of Fe₂P₂O₇, FeP, Fe₂P, and Fe₃P, and may also include dopants and/or modifiers.

In one instance, the materials of the present invention may be synthesized by a process wherein a group of starting materials, including compounds containing lithium, the metal, and a phosphate, are mixed together and reacted under reducing conditions, typically at elevated temperatures, to produce the composite material. In one specific group of processes, the starting materials are mixed together by grinding, as, for example, in a ball mill, attritor mill, mortar, or the like. The resultant mixture is then heated in a reducing environment. This reducing environment may be provided by a gaseous reducing atmosphere which may include one or more of hydrogen, a hydrocarbon and ammonia; although, other reducing gases such CO may also be utilized for the process. In other instances, the reducing environment may be provided by the inclusion of a solid or liquid reducing agent in the reaction mixture. The reducing conditions promote the formation of the second phase, for example by converting a portion of the phosphate to a subphosphate material. Also, in some instances, the metal component may be partially reduced.

It has also been found advantageous, in some instances, to include relatively small amounts of a catalyst which promotes the formation of the second phase. The catalyst may act directly on the phosphate ion so as to reduce it; or, it may indirectly promote the reduction, as for example by reducing another species so as to form a reducing agent that reduces the phosphate. For example, the catalyst may reduce a source of carbon, such as a solvent or other material used in the preparation of the reaction mixture; alternatively, it may reduce a metal found in the mixture so as to provide the secondary reductant. Alternatively, or in addition, the catalytic material may be a nucleating agent for growth of the second phase. In view of the foregoing, it will be understood that the term “catalyst which promotes reduction” is used and interpreted in its broadest sense. Such catalysts may comprise vanadium, which is typically employed in the form of a vanadium compound such as a vanadium oxide or the like. Catalysts are typically present in a range of 0.1-5 atomic percent of the mixture. EDX analysis suggests that the catalytic material is more likely to be found in the second phase than in the first. This indicates that the catalyst aids in promoting the formation of this second phase either by causing reduction of the phosphate, directly or indirectly, or by nucleating growth of the phase.

In one general process for the preparation of an iron-based composite material, a starting reaction mixture is prepared from a source of lithium which is a lithium salt, such as lithium carbonate. The iron and phosphate ions may both be provided by utilizing a material such as ferric phosphate, which is subsequently reduced to a ferrous compound under the reaction conditions. As noted above, a catalyst such as vanadium may be included in the mixture, typically in the form of an oxide of vanadium. This reaction mixture is heated, at atmospheric pressure, under a reducing atmosphere, as noted above, to a temperature of approximately 550-600° C. for 1.5-2.0 hours. Following the reduction, the material is cooled to room temperature, typically under an inert atmosphere. The material thus produced demonstrated excellent performance characteristics when incorporated into cathodes for lithium batteries.

In one specific procedure, a first material was prepared from a starting mixture comprising: Li₂CO₃, 0.02 M (1.4780 g) and FePO₄×H₂O, 0.04 M (7.0031 g with Fe content of 31.9%). A second material was prepared from a mixture comprising: Li₂CO₃, 0.02 M (1.4780 g); FePO₄×H₂O, 0.95×0.04 M (6.6530 g with Fe content of 31.9%) and V₂O₅, 0.05×0.02 M (0.1819 g). The mixtures were each ball milled for 96 hours in acetone with 2 mm and 5 mm YSZ balls. The acetone slurry was discharged from the bottle and dried in air. The powders were then ground with a mortar and pestle and transferred to quartz boats for a temperature programmed reduction reaction.

In the reaction, the mixtures were heated under a hydrogen atmosphere, at a flow rate of 1.26/min., according to the following schedule: RT→350° C., 2 hrs.; 350° C.→350° C., 2 hrs.; 350° C.→600° C., 3 hrs.; 600° C.→+600° C., 1.5 hrs. Thereafter, the samples were cooled to 100° C. and passivated in an O₂/He atmosphere.

In the vanadium-free sample, particles ranged in size from 50 nm to several microns, and the micron sized particles had nanometer sized features. EDX analysis of two 200 nm sized particles showed an atomic percent ratio of Fe:P:O of 29.4:28:42.6 and 25.8:28.5:45.7, indicating the presence of phosphate and partially reduced phosphate. EDX analysis of a micron sized whisker structure showed an atomic percent ratio for Fe:P:O of 49.1:48.9:2.0 indicating the presence of FeP. EDX of one spot on a micron sized whisker showed Na peaks with an atomic percent of 11.6. All other EDX on different spots showed an Fe:P ratio of around 1 with an atomic percent of 0 of 1.6 to 49.5 indicating the presence of phosphate, partially reduced phosphate and FeP, but there was no indication of Fe₂P or Fe₃P.

Similar analyses of the V containing material showed particle sizes ranging from 50 nm to several microns with nanometer sized features on the micron sized particles. EDX of one 150 nm particle showed Fe:P:O:V atomic percent ratios of 2.68:25.1:47.2:1.0 indicating the presence of phosphate and partially reduced phosphate. EDX of a 30 nm particle showed a Fe:P:O:V atomic percent ratio of 59.4:33.9:3.9:2.9 indicating the formation of Fe₂P with the presence of V. EDX of a 150 nm long whisker showed a Fe:P:O:V atomic percent ratio of 68.8:30.5:0.6:0.1 indicating the formation of Fe₂P and Fe₃P without the presence of V. EDX of three different sized whiskers showed the presence of Fe₂P. EDX of round particles showed no difference in phosphate formation in the bulk and at edges. The deflection pattern of LiFePO₄ indicates the olivine crystal structure.

The foregoing description has primarily been directed to iron containing materials; however, it is to be understood that composite materials based upon other metals may likewise be fabricated in accord with the principles of the present invention. Also, a material of the present invention has been described with primary reference to its use as a cathode material for lithium batteries. It is to be understood that this material, owing to its good electronic and ionic properties, will also have utility in other electrochemical applications, such as chemical reactors, other battery systems, electronic devices, and the like. Also, the material of the present invention will have utility in various catalytic applications both as an electrocatalyst and a non-electrocatalyst. Accordingly, it is to be understood that the foregoing description and discussion is illustrative of specific embodiments of the invention, but is not meant to be a limitation upon the practice thereof. It is the following claims, including all equivalents, which define the scope of the invention.

1. A composite material, said composite material comprising:
a first phase which is present in the form of a plurality of particles comprised of a material having the general formula: LiₓM_{y}(PO₄)_{z} wherein M is at least one metal, x is equal to or greater than 0, and y and z are each, independently, greater than 0; and
a second phase which is at least partially present in the form of a plurality of elongated filaments, each of which extends between, and establishes electrical contact with, at least two particles of said first phase, said filaments being comprised of a material which includes P, and at least one of said at least one metal M, the material of said second phase having an electrical conductivity which is greater than the electrical conductivity of the material of said first phase.

2. The composite material of claim 1, wherein M includes Fe.

3. The composite material of claim 1, wherein x is greater than 0.

4. The material of claim 1, wherein said second phase includes a material selected from the group consisting of: Fe₂P₂O₇, FeP, Fe₂P, Fe₃P, and combinations thereof.

5. The composite material of claim 1, wherein said first phase comprises, on a molar basis, 80-90% of said composite material, and said second phase comprises, on a molar basis, 5-20% of said composite material.

6. The composite material of claim 1, wherein at least one of said phases includes V.

7. The composite material of claim 6, wherein the concentration of V in the filaments of the second phase is greater than the concentration of V in the particles of said first phase.

8. The composite material of claim 1, wherein said composite material is prepared by a process comprising the steps of:
providing a starting mixture which includes M, a phosphate ion, optionally Li, and a catalyst which promotes reduction of the phosphate ion; and
heating said mixture in a reducing atmosphere so as to produce said composite material.

9. The composite material of claim 8, wherein in said process, the catalyst comprises V.

10. The composite material of claim 9, wherein in said process, said V is initially present in said starting mixture in the form of a compound of V.

11. The composite material of claim 8, wherein in said process, said step of heating said mixture comprises heating said mixture to a temperature in the range of 550-600° C.

12. The composite material of claim 8, wherein in said process, the reducing atmosphere includes one or more of hydrogen, carbon monoxide, a hydrocarbon and ammonia.

13. An electrode which includes the composite material of claim 1.

14. A composite material, said composite material comprising:
a first phase which is present in the form of a plurality of particles comprised of a material having the general formula LiₓM_{y}(PO₄)₂ wherein M is at least one metal, x is equal to or greater than zero, and y and z are each, independently, greater than zero; and
a second phase which establishes electrical contact with at least some of the particles of the first phase, said second phase being comprised of a material which includes P, and at least one of said at least one metal M, the material of said second phase having an electrical conductivity which is greater than the electrical conductivity of the material of said first phase;
wherein at least one of said first phase and said second phase includes vanadium.
